(19) United States
(12) Patent Application Publication
(10) Pub. No.: US 2012/0180581 A1
(43) Pub. Date: Jul. 19, 2012

(54) Method for Evaluating the Integrity of a Pitot-Static Based Airspeed Detector

(76) Inventor: George B. Foster, (US)

(21) Appl. No.: 13/186,037

(22) Filed: Jul. 19, 2011

Related U.S. Application Data
(60) Provisional application No. 61/365,395, filed on Jul. 19, 2010.

(51) Int. Cl. G01N 17/00

(52) U.S. Cl. 73/865.6

(57) ABSTRACT

Test pressure bursts are utilized to eject a burst of air into the two channels of a pitot-static airspeed detection system and decay times for that air pressure are evaluated with respect to aircraft altitude. A higher-pressure burst of air may be employed to clear ice from a pitot-static channels.

### CROSS-REFERENCE TO RELATED APPLICATIONS

This application claims the benefit of the provisional application having Ser. No. 61/365,395, filed Jul. 19, 2010, the disclosure of which is expressly incorporated herein by reference.

### STATEMENT REGARDING FEDERALLY SPONSORED RESEARCH

Not applicable.

### BACKGROUND

In 2009, an A330-200 airliner designated as Air France Flight 447 (AF 447) crashed into the Atlantic Ocean during its flight from Rio de Janeiro to Paris with the loss of all on board. It appeared that the aircraft encountered severe weather, including cumulus clouds and rain. Such weather can exhibit updrafts carrying super cooled liquid water at the center region of the cloud. That water will crystallize to form ice upon contact with the structure of an aircraft. At the outside region of such clouds, updrafts are commonly encountered. The result of such phenomena can result in airframe stress beyond design capability. During the AF 447 flight, its automatic communications and reporting system (Acars) broadcast messages to Air France, which indicated discrepancies in readouts among the several pitot-static speed sensors. It has been opined that icing of the sensors resulted in a measured airspeed that was lower than the aircraft's actual airspeed, resulting in a pilot or control system adding power to an already overtaxed airframe. One of the black box recording devices has since been recovered, also indicating invalid and inconsistent airspeed readouts.

Other pitot-static based aircraft failures include: Austral Lineas Aereas flight 2553; Birgenair flight 301; Northwest Orient Airline flight 6231; AeroPeru flight 603 (blocked static ports); and one X-31. While electrically powered heaters are available on most pitot-static installations, such approaches to control overicing do not appear to be effective.

The basic pitot tube was invented by the French hydraulic engineer Henri Pitot (1695-1771) later to be modified to its modern form by Henry Darcy. For conventional aircraft usage, pitot-static tubes, which are also referred to as “Prandtl” tubes are about 10 inches (25 cm) long with a ½ inch (1 cm) diameter. Several small holes are present around the outside of the tube and the center channel is disposed along the axis. The outside holes are connected to one side of a pressure transducer while the center channel couples to the opposite side of such device. By aligning the axis of the tube with the airflow passing the aircraft, a variety of aircraft flight control data including airspeed may be derived.

In general, Bernoulli's equation is used to derive velocity. In this regard, Bernoulli's equation may be expressed as follows:

$$( {p}_{s} + \frac{{rV}^{2}}{2} ) = {p}_{t} .$$

Solving for velocity V²=2(pₜ−pₛ)/r.

Since the outside holes are perpendicular to the direction of airflow, these tubes are pressurized by the local random component of air velocity. The pressure in these tubes is the static pressure, pₛ discussed above. The center tube, however, is pointed in the direction of travel and is pressurized by both the random and ordered air velocity. The pressure in this tube is the total pressure, pₜ discussed in the equation. The pressure transducer of the pitot-static tube measures the difference in total and static pressure which is the dynamic pressure, q. The square root function of the above is taken to derive velocity, v, and, r, is density.

### BRIEF SUMMARY

The present invention is directed to a method and system for evaluating the integrity of a pitot-static based airspeed detection system, one aircraft at an altitude having of at least one pitot-static system with a pitot pressure channel and a static air pressure channel. The method comprises the steps of providing a static pressure feed channel arrangement extending in pressure conveying relationship with a pitot navigation system;

Providing a static pressure feed valving assembly within the static pressure feed channel actuatable between on and closed conditions;

Providing a dynamic pressure feed channel arrangement extending in pressure conveying relationship with the pitot navigation system;

Providing a dynamic pressure feed valving assembly within the dynamic pressure feed channel actuatable between on and closed conditions;

Providing an active test pressure source at a predetermined pressure level above the current aircraft altitude flight pressure level;

Providing a compilation of pitot pressure channel no ice or no channel blocking based pressure decay time T1, of a predetermined burst of air from the active pressure test source for a plurality of altitudes at which the aircraft may fly;

Actuating the dynamic pressure feed valving assembly to a closed condition;

Applying a burst of air for predetermined interval to the pitot pressure channel and monitoring its decay interval to reach the current aircraft altitude flight level pressure;

Accessing decay time T1 from the compilation for the current aircraft altitude;

Determining the toll with decay time, T3 as a sum of no iced decay time, T1, plus any time extension, T2, thereof; and

Providing an airspeed fault signal in the presence of a time extension, T2.

The invention, accordingly, comprises the system and method possessing the construction, combination of elements, steps and arrangement of parts, which are exemplified in the following detailed disclosure.

For a fuller understanding of the nature and objects of the invention, reference should be had to the following detailed description taken in connection with the accompanying drawings.

### BRIEF DESCRIPTION OF THE DRAWINGS

FIG. 1 is a schematic representation of an airliner with a forward nose region laminar airflow about which are disposed 3 pitot-static tube systems;

FIG. 2 is a side view with portions shown in phantom of a pitot-static structure shown in FIG. 1;

FIG. 3 is a front view of the pitot-static structure shown in FIG. 2;

FIG. 4 is a block diagram of the system of the invention;

FIG. 5 is a pictorial representation of an in-cockpit read-out representing ice status and indicated airspeed; and

FIG. 6 is a chart showing the decay times for the absence and presence of ice in a pitot-static system.

### DETAILED DESCRIPTION

In the description to follow, the forward region of an aircraft is schematically portrayed in conjunction with the location of three pitot-static based airspeed inputs, whereupon a conventional pitot structure is illustrated. One pitot channel then is described with a schematic depiction of a pitot tube in conjunction with the method and system of the invention wherein the condition of the pitot assembly is monitored with respect to channel blockage occasioned by ice or the like and an approach for clearing the pitot whether at ground level or various altitudes. In conjunction with this system description a visually perceptible readout to an aircraft pilot is portrayed for three airspeed channels of performance and, finally, a chart is presented showing decay times for evaluating the presence and extend of blockage of ice or the like within a pitot channel.

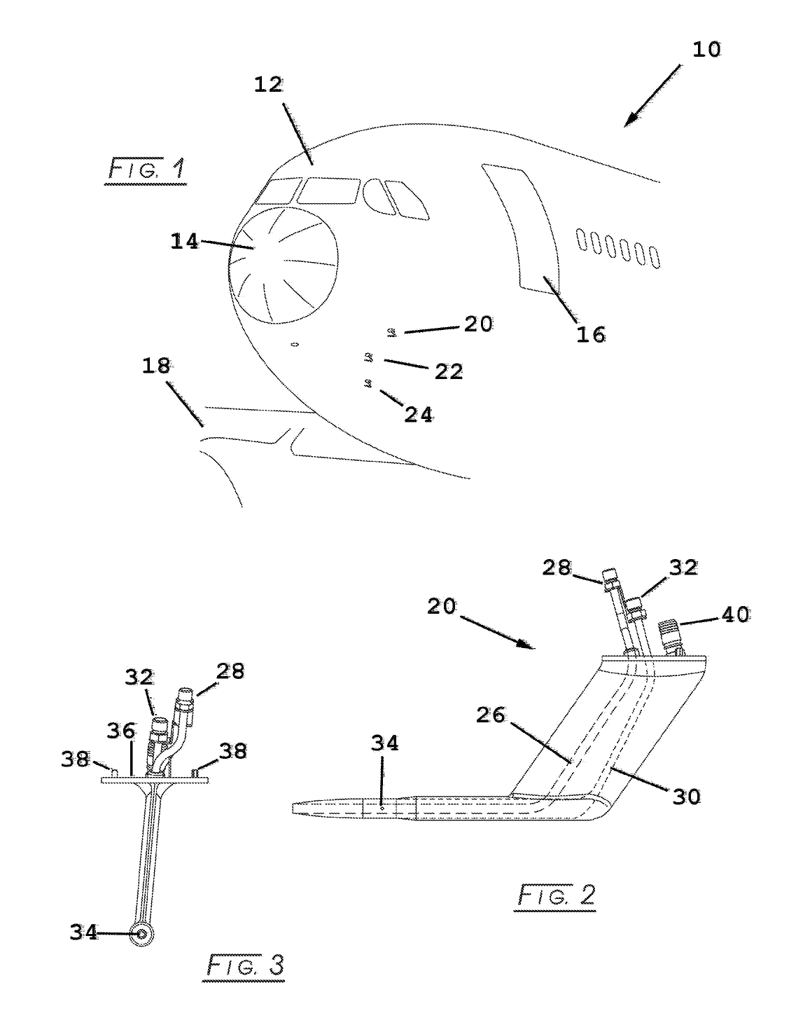

Referring to FIG. 1, the forward portion of an aircraft is schematically portrayed in general at 10. In this regard, aircraft 10 is seen to incorporate a forward cabin portion with windshields as at 12 and a forward dome 14. A forward access door is shown at 16 and a forwardly directed motor cowling is represented generally at 20. The inputs of three discrete pitot-static channels are shown 20-22. A side view of one such pitot-static tube is represented in FIG. 2 again using the numeral 20. Looking to that figure, a dynamic pressure feed channel is shown at 26 that extends to a fitting 28 and a corresponding static channel is shown at 30 extending to a fitting 32. A lateral opening is provided in the static channel and is shown at 34. A dynamic pressure feed channel opening is shown again in FIG. 3 with the same numeration as the static channel. Additionally, fittings 28 and 32 appear in FIG. 3 extending upwardly from a support platform 36, with locator pins as at 38 extending upwardly as well.

Returning to FIG. 2, an electrical fitting is shown at 40 which functions to apply current to a heating element or Julian device intended to melt deposited ice (not shown), or to prevent its accumulation.

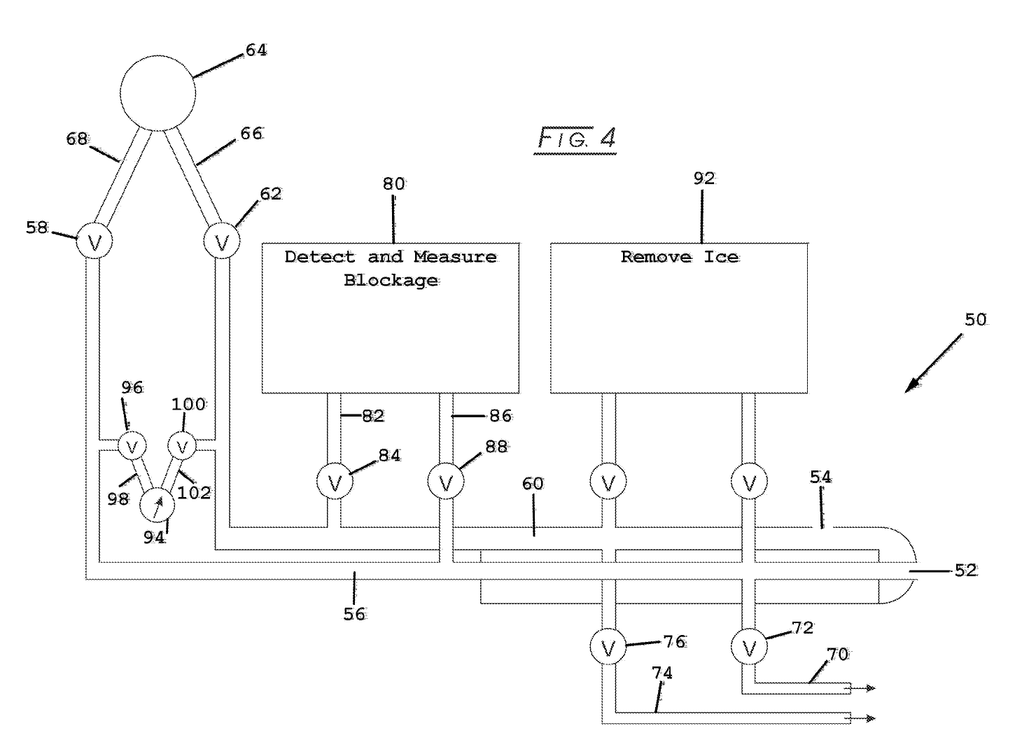

Turning to FIG. 4, a pitot-static tube is represented schematically in general at 50. Tube 50 is shown incorporating a dynamic pressure inlet 52 and a static pressure inlet 54. Dynamic pressure inlet 52 is incorporated with a dynamic pressure feed channel 56 that extends, in turn, to a dynamic test feed valving function 58. Correspondingly, static pressure inlet 54 is operationally associated with a static pressure feed channel 60. Channel 60, in turn, extends to a static test feed valving function 62. Note that valving functions 58 and 62 are operationally associated with an active test pressure source 64 carrying a pre-determined pressure level above any current aircraft altitude flight level pressure and, for example, may provide a test pressure of about 20 psi. Static test feed valving function 62 is associated operationally with source 64 via channel 66 while dynamic test feed valving function 58 is associated with that same source via channel 68.

Dynamic pressure is asserted along dynamic feed channel 70 to the dynamic pressure input to the aircraft navigational system. That input is regulated by dynamic pressure valving function 72. Correspondingly, the static feed pressure extends via static feed channel 74 to the navigation system and is controlled by a static pressure valving function 76.

A detect and measure blockage control function is shown at block 80. Static pressure input to control function 80 is shown at channel 82 incorporating a valving function 84. Correspondingly, dynamic pressure is asserted via conduit 86 containing valve 88 to function 80.

To proceed with the monitoring and measuring of ice conditions, the system at hand utilizes a collection of calibrating no ice decay times over a sequence of flight levels, for example, 420 such levels extending, for example, to a maximum altitude of about 30,000 feet. This collection may be compiled in a lookup table utilizing conventional computational technology.

The convention used for pitot-static systems today is to employ a “majority rules” operation to the three or more pitot-static detection systems employed on an aircraft by indicating the airspeed detected and measured by two of the three systems. If the majority of the pitot-static indicator systems have large but similar errors, however, the indicated airspeed will be incorrect. The present system first calculates the indicated airspeed by measuring the dynamic and static pressures via the dynamic feed channel 74 and static feed channel 70, respectively, then using the detect and measure blockage control function to quantify any error due to iced conditions, followed by providing a corrected airspeed to the cockpit.

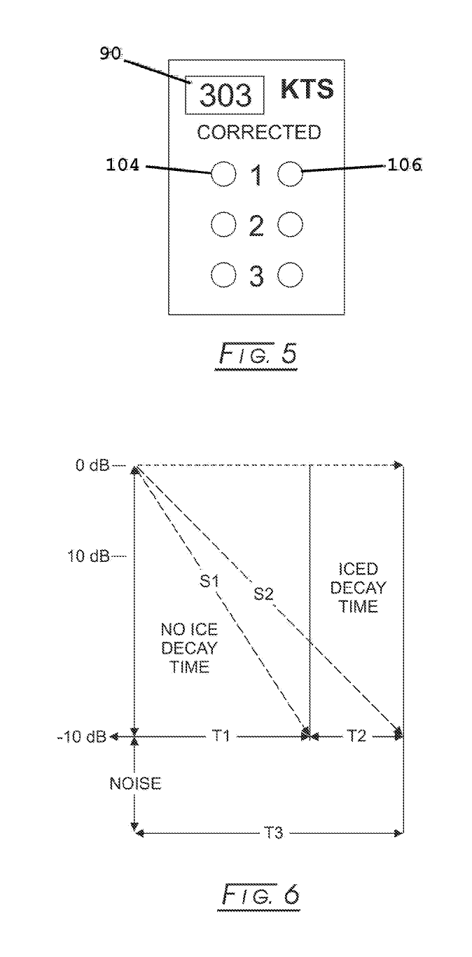

Detect and measure function 80 monitors initially by closing valving function 72 and 76. In this regard, a short burst of air under pressure is developed from source 64 initially via valve 58 and channel 68 whereupon that burst of air pressure above the altitude base pressure is measured as an iced decay time. Such a decay time for a no-iced condition is represented in FIG. 6 as curve S1. On the other hand, should there be ice or some blockage in the pitot system, then the decay time will expand as represented at curve S2, adding a time T2 to the no-iced decay time T1. From these two times a ratio R_{c} can be devise as T2/T1. This gives the system an indication as to: 1) the presence of ice at the pitot system; and 2) the extent and quantification of such ice. Note that the sum of times T1 and T2 is represented as T3. Returning to FIG. 4, the same test can be carried out using source 64, valving function 62, and channel 66 extending to the static pressure feed channel 60. The ratio R_{c} also can be used to evolve a corrected airspeed, which is then published to the pilot as represented in FIG. 5 at 90. This is labeled “corrected” airspeed and is expressed in knots. Essentially all pitot-static systems contain a resistive heating component, which also can be activated at this time labeled.

The function at block 92 serves to clear the dynamic pressure feed channel as well as the static pressure feed channel. This is carried out with a higher pneumatic pressure source represented at symbol 94. Now the pneumatic pressure, for example, 90 psi, is used for clearance purposes. In this regard, looking initially to the dynamic pressure feed channel 56, valving function 96 is opened to create an ice-clearing burst of air from source 94 as represented at channel 98 and its connection with dynamic pressure feed channel 56. Similarly, the static pressure feed channel may be cleared of ice or the like by actuating valve 100 and providing the high burst of pneumatic pressure to the static pressure feed channel 60. Following this ice-clearing procedure, the static and dynamic channels are again tested via detect and measure control function 80 to assure the removal of blockage or ice. In the event such blockage is not removed, then the procedure is carried out again.

Using this system and method, the error present in the indicated airspeed for each of the pitot-static systems employed in an aircraft flight system can be continually monitored and used to indicated a corrected airspeed. Thus, the pitot-static system with the lowest error can be displayed to the pilots, while the remaining channels are monitored and de-iced. Returning to FIG. 5, perceptible indicators can be provided to the pilot, for example, showing a successful test with a green light for the online channel, as at 104 for the first channel, or a blinking yellow visual output at 104 for a successful test if it is an offline channel. The indicators in the right column, as at 106, can show red for the presence of ice above a threshold error beyond the normal operating limit, for example 10%. The indicator 106 could also display yellow for the presence of ice introducing, for example, an error between 0% and 10%.

Since certain changes may be made in the above-described system and method without departing from the scope of the invention herein, it is intended that all matter contained in the description thereof or shown in the accompanying drawings shall be interpreted as illustrative and not in a limiting sense.

I claim:

1. A method for evaluating the integrity of a pitot-static based airspeed detection system for an aircraft at an altitude having at least one pitot-static system with a pitot pressure channel and a static air pressure channel, comprising the steps:
providing a static pressure feed channel arrangement extending in pressure conveying relationship with a pitot navigation system;
providing a static pressure feed valving assembly within the static pressure feed channel actuatable between on and closed conditions;
providing a dynamic pressure feed channel arrangement extending in pressure conveying relationship with the pitot navigation system:
providing a dynamic pressure feed valving assembly within the dynamic pressure feed channel actuatable between on and closed conditions;
providing an active test pressure source at a predetermined pressure level above the current aircraft altitude flight level pressure;
providing a compilation of pitot pressure channel, no ice or no channel blocking based pressure decay times, T1, of a predetermined burst of air from the active pressure test source for a plurality of altitudes at which the aircraft may fly;
actuating the dynamic pressure feed valving assembly to a closed condition;
applying a burst of air for a predetermined interval to the pitot pressure channel and monitoring its decay interval to reach or approach the current aircraft altitude flight level pressure;
accessing decay time T1, from the compilation for the current aircraft altitude;
determining the total decay time, T3, as the sum of no iced decay time, T1, plus any time extension, T2, thereof; and
providing an airspeed fault signal in the presence of a time extension, T2.

2. The method of claim 1 further comprising the step:
determining the ratio R_{c} as T3/T1 and altering the indicated airspeed of the aircraft by multiplying it by R_{c} when R_{c} is greater than one.

3. The method of claim 1 further comprising the step:
applying heat to the pitot pressure channel to maintain it above freezing temperature when the ration R_{c} is greater than one.

4. The method of claim 2 further comprising the steps:
providing a source of clear vent air under a pressure effective when actuated to blow ice from the pitot pressure channel.
